(19) United States
(12) Patent Application Publication
(10) Pub. No.: US 2015/0180009 A1
(43) Pub. Date: Jun. 25, 2015

(54) BATTERY PACK

(71) Applicant: Samsung SDI Co., Ltd., Yongin-si (KR)

(72) Inventor: Hun-Tae Ro, Yongin-si (KR)

(21) Appl. No.: 14/540,959

(22) Filed: Nov. 13, 2014

(30) Foreign Application Priority Data
Dec. 19, 2013 (KR) 10-2013-0159633

(51) Int. Cl. H01M 2/34; H01M 10/052

(52) U.S. Cl. CPC H01M 2/34; H01M 10/052; H01M 2200/00; H01M 2220/30; H01M 2220/20

(57) ABSTRACT

A battery pack is disclosed. In one aspect, the batter pack includes a core pack including a plurality of secondary batteries, a protection circuit module electrically connected to the core pack, and first and second pieces accommodating the core pack and the protection circuit module, wherein the protection circuit module includes a first connection terminal, a second connection terminal, and a plurality of blocks placed adjacent to each of the first and second connection terminals, and wherein each of the blocks contacts one of the connection terminals so as to force the first and second connection terminals towards each other.

### RELATED APPLICATIONS

This application claims the benefit of Korean Patent Application No. 10-2013-0159633, filed on Dec. 19, 2013, in the Korean Intellectual Property Office, the disclosure of which is incorporated herein in its entirety by reference.

### BACKGROUND

1. Field

The described technology generally relates to a battery pack.

2. Description of the Related Technology

Unlike primary batteries, secondary batteries are capable of being charged and discharged. For this reason, secondary batteries, also known as rechargeable batteries, are more economical and eco-friendly than primary batteries, and thus, used widely. Furthermore, the number of applications for the secondary battery is expanding.

Secondary battery configurations can include a single battery cell or a plurality of battery cells that are electrically connected to one another, based on an electronic device that is electrically connected to them. For example, a small device, such as a mobile phone, operates for a predetermined time by using one battery. On the other hand, a larger electronic device, such as a laptop, a machine tool or an electric scooter, requires a higher output and capacity than that of the small device. Thus, a battery pack including a plurality of batteries connected in series and/or parallel can be used as a power supply for the larger electronic device.

A battery pack can be physically combined to and supply power to the electronic device.

### Summary of Certain Inventive Aspects

One inventive aspect is a battery pack capable of being stably electrically connected to an external electronic device.

Another aspect is a battery pack that includes: a core pack including a plurality of secondary batteries; a protection circuit module electrically connected to the core pack; and first and second cases accommodating the core pack and the protection circuit module, and combined to each other, wherein the protection circuit module includes a first connection terminal unit, a second connection terminal unit, and a plurality of block units disposed outside each of the first and second connection terminal units, and the plurality of block units each thermally contact the first or second connection terminal unit, and pressurize the first and second connection terminal units via thermal expansion.

Each of the plurality of block units can include a metal body and an insulating layer formed on an outer surface of the metal body, wherein the insulating layer can be formed of an oxide of a metal forming the metal body.

The first and second connection terminal units can each include first and second combining units facing each other, wherein the first and second combining units can each include a guiding unit, a connecting unit, and a contacting unit between the guiding unit and the connecting unit.

The first and second combining units can be symmetrical, the contacting unit of the first combining unit can have a protruding shape towards the second combining unit, and the contacting unit of the second combining unit can have a protruding shape towards the first combining unit.

A first surface of each of the plurality of block units can contact an outer surface of the connecting unit, and each of the plurality of block units can pressurize the connecting unit via the thermal expansion.

The first case can include a plurality of wall units fixing a location of each of the plurality of block units.

Each of the plurality of wall units can contact a second surface of each of the plurality of block units, which is an opposite surface of the first surface.

The connecting unit of the first combining unit and the connecting unit of the second combining unit can be integrally formed as one ends thereof are connected to each other.

The battery pack can further include a support unit for supporting the protection circuit module.

The first case can include a first terminal hole for exposing the first connection terminal unit and a second terminal hole for exposing the second connection terminal unit.

Another aspect is a battery pack that includes: a first case; a core pack accommodated in the first case; a protection circuit module electrically connected to the core pack and including first and second connection terminal units; and a second case combined to the first case, wherein the protection circuit module includes a plurality of block units disposed outside each of the first and second connection terminal units, and the plurality of block units each include a metal body and an insulating layer formed on an outer surface of the metal body, and pressurize the first and second connection terminal units via thermal expansion.

The first and second connection terminal units can each include first and second combining units facing each other, the first and second combining units can each include a guiding unit, a connecting unit, and a contacting unit between the guiding unit and the connecting unit, and a first surface of each of the plurality of block units can contact an outer surface of the connecting unit.

Each of the plurality of block units can thermally contact the connecting unit.

The first and second combining units can be symmetrical, the contacting unit of the first combining unit can have a protruding shape towards the second combining unit, and the contacting unit of the second combining unit can have a protruding shape towards the first combining unit.

Each of the plurality of block units can pressurize the connecting unit via the thermal expansion.

The first case can include a plurality of wall units for fixing a location of each of the plurality of block units.

Each of the plurality of wall units can contact a second surface of each of the plurality of block units, wherein the second surface can be an opposite surface of the first surface, and the plurality of wall units can prevent the thermal expansion of the plurality of block units towards the second surface.

The connecting unit of the first combining unit and the connecting unit of the second combining unit can be integrally formed as one ends thereof are connected to each other, and the first and second combining units can be elastic.

The first case can include a first terminal hole for exposing the first connection terminal unit and a second terminal hole for exposing the second connection terminal unit.

Each of the plurality of block units can include a metal body and an insulating layer formed on an outer surface of the metal body, wherein the insulating layer can be formed of an oxide of a metal forming the metal body.

Another aspect is a battery pack, comprising: a core pack including a plurality of secondary batteries; a protection circuit module electrically connected to the core pack; and first and second pieces accommodating the core pack and the protection circuit module, wherein the protection circuit module comprises a first connection terminal, a second connection terminal, and a plurality of blocks placed adjacent to each of the first and second connection terminal, and wherein each block contacts one of the connection terminals so as to force the first and second connection terminals towards each other.

In the above battery pack, each block comprises a metal body and an insulating layer formed on an outer surface of the metal body, wherein the metal body is formed at least partially of metal, and wherein the insulating layer is formed at least partially of an oxide of the metal. In the above battery pack, the connection terminals comprise first and second combining units facing each other, and wherein each combining unit comprises a guiding unit, a connector, and a contacting unit placed between the guiding unit and the connector.

In the above battery pack, the first and second combining units are substantially symmetrical, wherein the contacting unit of the first combining unit protrudes towards the second combining unit, and wherein the contacting unit of the second combining unit protrudes towards the first combining unit. In the above battery pack, a first surface of each block contacts an outer surface of the connector. In the above battery pack, the first piece comprises a plurality of walls formed to fasten each block.

In the above battery pack, each wall contacts a second surface of each block, which is an opposite surface of the first surface. In the above battery pack, the connector of the first combining unit and the connector of the second combining unit are integrally formed. The above battery pack further comprises a support unit placed to fasten the protection circuit module. In the above battery pack, the first piece comprises a first terminal hole for exposing the first connection terminal and a second terminal hole for exposing the second connection terminal.

Another aspect is a battery pack, comprising: a first piece accommodating a core pack; and a protection circuit module comprising first and second connection terminals, wherein the protection circuit module is electrically connected to the core pack; and a second piece configured to be combined with the first piece, wherein the protection circuit module comprises a plurality of blocks placed outside each of the first and second connection terminals, and wherein each block comprises a metal body and an insulating layer formed on an outer surface of the metal body so as to force the first and second connection terminals towards each other.

In the above battery pack, the first and second connection terminals each comprises first and second combining units facing each other, wherein the first and second combining units each comprises a guiding unit, a connector, and a contacting unit between the guiding unit and the connector, and wherein a first surface of each block contacts an outer surface of the connector. In the above battery pack, each block contacts the connector. In the above battery pack, the first and second combining units are substantially symmetrical, wherein the contacting unit of the first combining unit protrudes towards the second combining unit, and wherein the contacting unit of the second combining unit protrudes towards the first combining unit.

In the above battery pack, the first piece comprises a plurality of wall units for fastening each block. In the above battery pack, each wall unit contacts a second surface of each block, wherein the second surface is an opposite surface of the first surface, and wherein the wall units substantially prevent the thermal expansion of the blocks towards the second surface. In the above battery pack, the connector of the first combining unit and the connector of the second combining unit are integrally formed, and wherein the first and second combining units are elastic.

In the above battery pack, the first piece comprises a first terminal hole for exposing the first connection terminal and a second terminal hole for exposing the second connection terminal. In the above battery pack, each block comprises a metal body and an insulating layer formed on an outer surface of the metal body, wherein the metal body is formed at least partially of metal, and wherein the insulating layer is formed of an oxide of the metal.

Another aspect is a battery pack, comprising: a core pack including a plurality of secondary batteries; a protection circuit module electrically connected to the core pack; a first piece and a second piece accommodating the core pack and the protection circuit module, wherein the first piece includes a plurality of walls, wherein the protection circuit module includes a plurality of connectors and a plurality of blocks, wherein a first surface of the block contacts one of the connectors, and wherein a second surface of the block contacts one or more of the walls.

In the above battery pack, each block comprises a metal body and an insulating layer formed on an outer surface of the metal body, wherein the metal body is formed at least partially of metal, and wherein the insulating layer is formed at least partially of an oxide of the metal.

### BRIEF DESCRIPTION OF THE DRAWINGS

FIG. 1 is a perspective view schematically illustrating a battery pack according to an embodiment.

FIG. 2 is an exploded perspective view of the battery pack of FIG. 1.

FIG. 3 is an enlarged perspective view of a part of a core pack of FIG. 2.

FIG. 4 is a cross-sectional view taken along a line I-I of FIG. 2.

FIG. 5 is a cross-sectional view taken along a line II-II of FIG. 1.

### DETAILED DESCRIPTION OF CERTAIN INVENTIVE EMBODIMENTS

As the described technology allows for various changes and numerous embodiments, exemplary embodiments will be illustrated in the drawings and described in detail in the written description. However, this is not intended to limit the described technology to particular modes of practice, and it will to be appreciated that all changes, equivalents, and substitutes that do not depart from the spirit and technical scope of the described technology are encompassed. In the description of the described technology, certain detailed explanations of related art are omitted when it is deemed that they can unnecessarily obscure the essence of the described technology.

While such terms as “first,” “second,” etc., can be used to describe various components, such components must not be limited to the above terms. The above terms are used only to distinguish one component from another.

The terms used in the present specification are merely used to describe particular embodiments, and are not intended to limit the described technology. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof can exist or can be added.

As used herein, the term “and/or” includes any and all combinations of one or more of the associated listed items.

One or more embodiments will be described below in more detail with reference to the accompanying drawings.

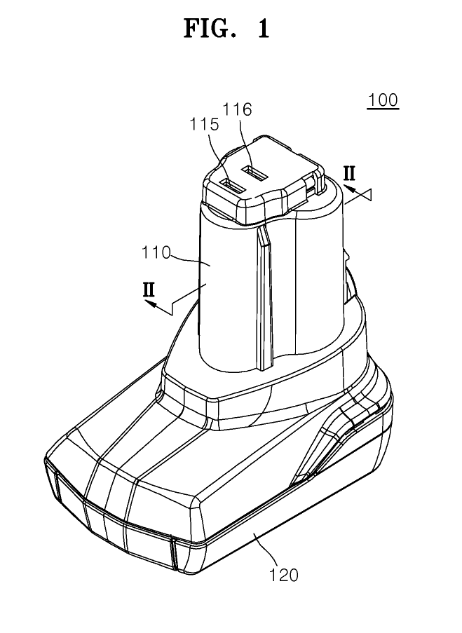

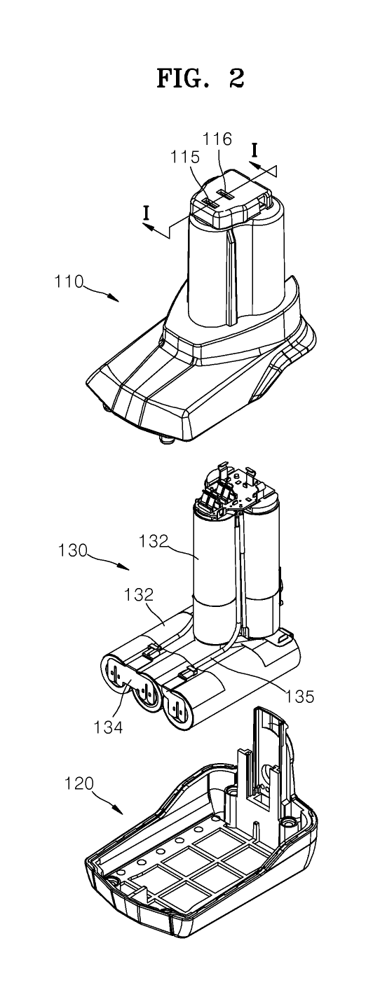

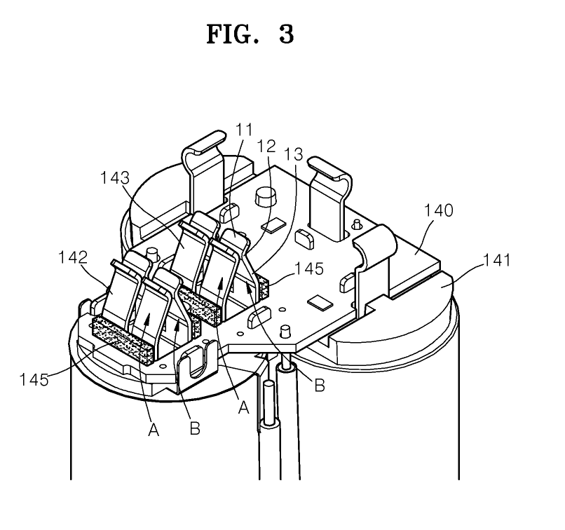

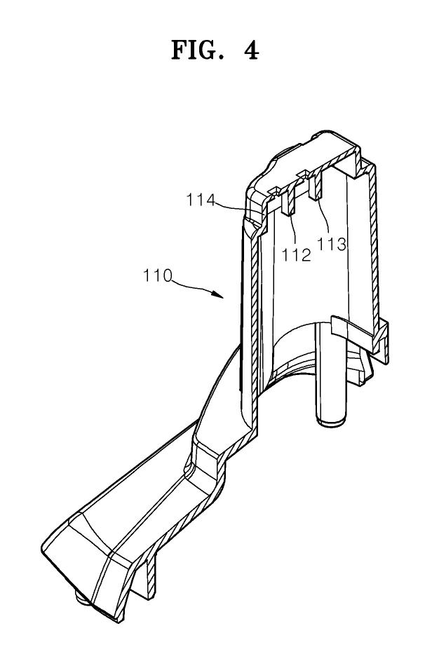

Referring to FIGS. 1 through 5, the battery pack 100 according to an embodiment can include first and second cases or pieces 110 and 120 combined to each other, the core pack 130 including a plurality of secondary batteries 132, and a protection circuit module 140 electrically connected to the core pack 130.

The first and second cases 110 and 120 can be combined to form an embodiment of the battery pack 100. The first and second cases 110 and 120 can accommodate the core pack 130 and the protection circuit module 140. The combined first and second cases 110 and 120 can substantially protect the core pack 130 and the protection circuit module 140 from environmental elements (e.g., water) and impacts (e.g., falling and hitting the ground). The shape of the first and second cases 110 and 120 can vary by considering a way in which the battery pack 100 and an electronic device (not shown) combine, and a shape of the core pack 130.

The first and second cases 110 and 120 can be formed at least partially of a material having insulation and good mechanical strength. For example, the first and second cases 110 and 120 can be formed of a polymer material, such as polycarbonate, but are not limited thereto.

Each secondary battery 132 can be connected in series and/or parallel and repeatedly charged and discharged by including an electrode assembly.

The electrode assembly can include a negative electrode plate and a positive electrode plate (not shown), and a separator placed between the negative and positive electrode plates. The positive electrode can be coated with electrode active materials. In some embodiments, the electrode assembly can have a jelly roll shape and can be manufactured by sequentially stacking the negative electrode plate, the separator, and the positive electrode plate.

The positive electrode plate can include a positive electrode active portion on which a positive electrode active material is coated, and a positive electrode plain portion on which the positive electrode active material is not coated. The positive active material can be a lithium chalcogenide compound or a lithium-containing transition metal oxide, such as LiOcO2, LiNiO2, LiMnO2, or LiMnO4.

The positive electrode active portion can be formed by coating the positive electrode active material on a portion of at least any one surface of an aluminum plate. The remaining portion of the aluminum plate where the positive electrode active material is not coated can be the positive electrode plain portion.

The negative electrode plate can include a negative electrode active portion on which a negative electrode active material is coated, and a negative electrode plain portion on which the negative electrode active material is not coated. The negative active material can be a lithium metal, a lithium alloy, or a carbon material, such as crystalline carbon, amorphous carbon, a carbon complex, or carbon fiber.

The negative electrode active portion can be formed by coating the negative electrode active material on a portion of at least any one surface of a copper plate. The remaining portion of the copper plate where the negative electrode active material is not coated can be the negative electrode plain portion.

The separator can be manufactured by coating polyvinylidene fluoride-hexafluoropropylene (PVDF-HFP) copolymer on polyethylene (PE), polystyrene (PS), polypropylene (PP) or a copolymer of PE and PP, but is not limited thereto.

The secondary batteries 132 can be electrically connected to one another through a connecting plate 134 and a lead wire 135.

The protection circuit module 140 can substantially prevent the secondary batteries 132 from being overheated and exploding due to overcharging or drawing too much current (overcurrent).

The protection circuit module 140 can include a substrate and a protection device mounted on the substrate. The substrate can be a printed circuit board, and the protection device can include an integrated circuit or a safety device including a passive device, such as a resistor and a condenser, or an active device, such as a field-effect transistor. The protection circuit module 140 can be placed on a support unit 141. The support unit 141 can fasten the protection circuit module 140.

The protection circuit module 140 can include a first connection terminal unit or first terminal 142, a second connection terminal unit or second terminal 143, and a plurality of block units or blocks 145 placed outside each of the first and second connection terminal units 142 and 143.

The first and second connection terminal units 142 and 143 can be electrically connected to the electronic device. The first case 110 can include a first terminal hole 115 for at least partially exposing the first connection terminal unit 142 and a second terminal hole 116 for at least partially exposing the second connection terminal unit 143.

The first and second connection terminal units 142 and 143 can each include first and second combining units A and B facing each other. Also, the first and second combining units A and B can each include a guiding unit 11, a connecting unit or connector 13, and a contacting unit 12 placed between the guiding unit 11 and the connecting unit 13.

The guiding unit 11, the contacting unit 12, and the connecting unit 13 can be integrally formed as the first or second combining unit A or B. The first and second combining units A and B can be formed so as to be bent. For example, the guiding unit 11 and the connecting unit 13 can include inclined surfaces having opposite gradients based on a horizontal plane. The contacting unit 12 can be protruding in one direction.

The first and second combining units A and B can be substantially symmetrical. For example, the contacting unit 12 of the first combining unit A can protrude towards the second combining unit B, and the contacting unit 12 of the second combining unit B can protrude towards the first combining unit A. Also, the guiding units 11 of the first and second combining units A and B can have open upwardly.

Accordingly, when a connection terminal of the electronic device is inserted to be connected to the first or second connection terminal unit 142 or 143, the connection terminal can be guided to the correct location by the guiding units 11. An electric connection can be established by the contacting units 12.

The connecting units 13 of the first and second combining units A and B can be integrally formed. Thus, the first and second combining units A and B can be elastic. For example, when the connection terminal of the electronic device is inserted, the first and second combining units A and B are opened in directions indicated by arrows \textcircled{1}. An elastic force is substantially simultaneously applied to the first and second combining units A and B in directions indicated by arrows \textcircled{2}. Accordingly, a contact resistance between the connection terminal and the contacting units 12 can be substantially reduced.

A first surface of each block unit 145 can be placed to contact an outer surface of the connecting unit 13.

Each block unit 145 can include a metal body and an insulating layer formed on an outer surface of the metal body. The metal body can be formed at least partially of a metal. The insulating layer can be formed at least partially of an oxide of a metal. For example, the metal body can be formed at least partially of aluminum and the insulating layer can be formed at least partially of alumina, but are not limited thereto.

Heat can be generated while operating the battery pack 100 and transferred to the first and second connection terminal units 142 and 143. In some embodiments, the block units 145 absorb and release the heat, thereby reducing the heat.

When the temperature of a metal increases, the resistance of the metal also increases. When the block units 145 reduce the heat, the resistance of the first and second connection terminal units 142 and 143 can substantially remain the same. Thus, the first case 110 can be substantially prevented from being damaged by the heat.

Also, the block units 145 can expand by absorbing heat, and force the connecting unit 13 towards a central axis via thermal expansion.

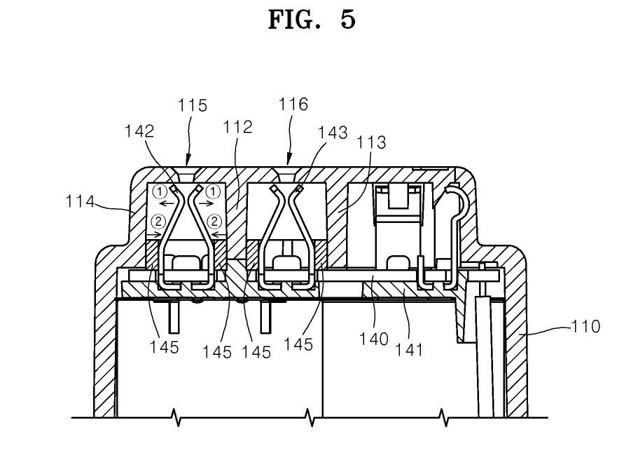

In detail, the first and second connection terminal units 142 and 143 are heated while the battery pack 100 is operated, and the heated first and second connection terminal units 142 and 143 can be opened in the directions indicated by the arrows \textcircled{1} of FIG. 5. Here, the block units 145 thermally contacting the first and second connection terminal units 142 and 143 thermally expand, and can force the connecting unit 13 in the directions indicated by the arrows \textcircled{2} of FIG. 5.

In other words, when the block units 145 push the first and second combining units A and B from two sides, the contact resistance between the connection terminal of the electronic device and the first and second connection terminal units 142 and 143 is substantially reduced, and thus the battery pack 100 and the electronic device can be stably electrically connected to each other.

The first case 110 can include a plurality of wall units or walls for substantially fastening the block units 145 in place. The wall units can extend from the top of the first case 110 towards the protection circuit module 140, and can contact a second surface of the block units 145. In some embodiments, the second surface of the block unit 145 is the opposite surface of the first surface contacting the connecting unit 13.

The wall units can include, for example, a first wall unit or first wall 112 and a second wall unit or second wall 113. Also, a portion of the first case 110 can operate as a third wall unit 114. The first connection terminal unit 142 can be placed between the first and third wall units 112 and 114, and the second connection terminal unit 143 can be placed between the first and second wall units 112 and 113. Also, side wall units connecting the first wall unit 112 and end portions of the second wall unit 113, and side wall units connecting end portions of the first wall unit 112 and the third wall unit 114 can be further formed to surround the first connection terminal unit 142, the second connection terminal unit 143, and the block units 145.

The wall units fasten the block units 145, and substantially prevent the block units 145 from thermally expanding towards the second surface.

As described above, according to the one or more of the above embodiments of the described technology, a contact resistance between a connection terminal of a battery pack and a connection terminal of an electronic device is reduced. Therefore, the battery pack and the electronic device can be stably electrically connected to each other.

While one or more embodiments have been described with reference to the figures, it will be understood by those of ordinary skill in the art that various changes in form and details can be made therein without departing from the spirit and scope of the described technology as defined by the following claims.

What is claimed is:

1. A battery pack, comprising:
a core pack including a plurality of secondary batteries;
a protection circuit module electrically connected to the core pack; and
first and second pieces accommodating the core pack and the protection circuit module,
wherein the protection circuit module comprises a first connection terminal, a second connection terminal, and a plurality of blocks placed adjacent to each of the first and second connection terminal, and
wherein each block contacts one of the connection terminals so as to force the first and second connection terminals towards each other.

2. The battery pack of claim 1, wherein each block comprises a metal body and an insulating layer formed on an outer surface of the metal body,
wherein the metal body is formed at least partially of metal, and
wherein the insulating layer is formed at least partially of an oxide of the metal.

3. The battery pack of claim 1, wherein the connection terminals comprise first and second combining units facing each other, and
wherein each combining unit comprises a guiding unit, a connector, and a contacting unit placed between the guiding unit and the connector.

4. The battery pack of claim 3, wherein the first and second combining units are substantially symmetrical,
wherein the contacting unit of the first combining unit protrudes towards the second combining unit, and
wherein the contacting unit of the second combining unit protrudes towards the first combining unit.

5. The battery pack of claim 4, wherein a first surface of each block contacts an outer surface of the connector.

6. The battery pack of claim 5, wherein the first piece comprises a plurality of walls formed to fasten each block.

7. The battery pack of claim 6, wherein each wall contacts a second surface of each block, which is an opposite surface of the first surface.

8. The battery pack of claim 4, wherein the connector of the first combining unit and the connector of the second combining unit are integrally formed.

9. The battery pack of claim 1, further comprising a support unit placed to fasten the protection circuit module.

10. The battery pack of claim 1, wherein the first piece comprises a first terminal hole for exposing the first connection terminal and a second terminal hole for exposing the second connection terminal.

11. A battery pack, comprising:
a first piece accommodating a core pack; and
a protection circuit module comprising first and second connection terminals, wherein the protection circuit module is electrically connected to the core pack; and
a second piece configured to be combined with the first piece,
wherein the protection circuit module comprises a plurality of blocks placed outside each of the first and second connection terminals, and
wherein each block comprises a metal body and an insulating layer formed on an outer surface of the metal body so as to force the first and second connection terminals towards each other.

12. The battery pack of claim 11, wherein the first and second connection terminals each comprises first and second combining units facing each other,
wherein the first and second combining units each comprises a guiding unit, a connector, and a contacting unit between the guiding unit and the connector, and
wherein a first surface of each block contacts an outer surface of the connector.

13. The battery pack of claim 12, wherein each block contacts the connector.

14. The battery pack of claim 12, wherein the first and second combining units are substantially symmetrical,
wherein the contacting unit of the first combining unit protrudes towards the second combining unit, and
wherein the contacting unit of the second combining unit protrudes towards the first combining unit.

15. The battery pack of claim 1, wherein the first piece comprises a plurality of wall units for fastening each block.

16. The battery pack of claim 15, wherein each wall unit contacts a second surface of each block, wherein the second surface is an opposite surface of the first surface, and
wherein the wall units substantially prevent the thermal expansion of the blocks towards the second surface.

17. The battery pack of claim 14, wherein the connector of the first combining unit and the connector of the second combining unit are integrally formed, and
wherein the first and second combining units are elastic.

18. The battery pack of claim 11, wherein the first piece comprises a first terminal hole for exposing the first connection terminal and a second terminal hole for exposing the second connection terminal.

19. The battery pack of claim 11, wherein each block comprises a metal body and an insulating layer formed on an outer surface of the metal body,
wherein the metal body is formed at least partially of metal, and
wherein the insulating layer is formed of an oxide of the metal.

20. A battery pack, comprising:
a core pack including a plurality of secondary batteries;
a protection circuit module electrically connected to the core pack;
a first piece and a second piece accommodating the core pack and the protection circuit module,
wherein the first piece includes a plurality of walls,
wherein the protection circuit module includes a plurality of connectors and a plurality of blocks,
wherein a first surface of the block contacts one of the connectors, and
wherein a second surface of the block contacts one or more of the walls.

21. The battery pack of claim 20, wherein each block comprises a metal body and an insulating layer formed on an outer surface of the metal body,
wherein the metal body is formed at least partially of metal, and
wherein the insulating layer is formed at least partially of an oxide of the metal.
